(19) United States
(12) Patent Application Publication
(10) Pub. No.: US 2009/0257752 A1
(43) Pub. Date: Oct. 15, 2009

(54) NETWORK MEDIA SELECTING METHOD AND DEVICE THEREOF

(75) Inventors: Ming-Yuh Yeh, Hsinchu City (TW); Wei-Po Wang, Hsinchu City (TW); Po-Wei Liu, Hsinchu City (TW); Yao-Feng Lin, Hsinchu City (TW); Shih-Hsuan Chiu, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: REALTEK SEMICONDUCTOR CORP., Hsinchu City (TW)

(21) Appl. No.: 12/423,732

(22) Filed: Apr. 14, 2009

(30) Foreign Application Priority Data
Apr. 14, 2008 (TW) 97113534

(51) Int. Cl. H04B 10/00

(52) U.S. Cl. 398/115

(57) ABSTRACT

A method for operating a network device is provided. The method comprises steps of providing a first transceiver to establish a first link via a first medium; providing a second transceiver to establish a second link via a second medium; and enabling one of the first and the second transceivers to establish a corresponding one of the first and second links according to a predetermined order, wherein a media access controller transmits a first datum via the first medium by using the first link, and transmits a second datum via the second medium by using the second link.

### FIELD OF THE INVENTION

The present invention relates to a media selecting method and device thereof, and more particular to a network media selecting method and device thereof.

### BACKGROUND OF THE INVENTION

In this diverse network age, the choices for the network media are also diverse. Nowadays, the current network media include a optic fiber, a copper cable, a coaxial cable, a twisted pair cable, etc., and current network devices are almost able to contain or be connected to more than one network medium concurrently. It is an important issue to determine when to connect what medium in what operation mode.

In a conventional ether net technology, an auto-negotiation sub-layer is used to exchange data between two network devices and adjust these two network devices into a most appropriate status to establish a connection or a link therebetween. A receipt of a received signal, a recognition of a common operation mode, and a refusal of a operation mode failing to be shared or simultaneously supporting these two network devices are included in the contents of the exchanged data for adjusting and choosing a proper operation mode. However, it is inefficient to use such adjustment, so in U.S. Pat. No. 7,054,309B1, two auto-negotiation circuits are used to connect to two different network media respectively, wherein when the linkage between one of these two network media and the network device is established through one auto-negotiation circuit, the other auto-negotiation circuit will be turned off by a media selector. Since one auto-negotiation circuit is only able to connect to one network medium, the efficiency for adjusting the network device is higher in establishing the linkage. However, it consumes a lot of power to monitor two network media concurrently and continuously.

### SUMMARY OF THE INVENTION

In accordance with an aspect of the present invention, a method for operating a network device is provided. The method comprises steps of providing a first transceiver to establish a first link via a first medium; by providing a second transceiver to establish a second link via a second medium; and enabling one of the first and the second transceivers to establish a corresponding one of the first and second links according to a predetermined order, wherein a media access controller transmits a first datum via the first medium by using the first link, and transmits a second datum via the second medium by using the second link.

Preferably, the method further comprises steps of establishing the first link in an adjustable period; generating a first connection signal while the first transceiver receives a first signal via the first medium after the first transceiver is enabled; disabling the second transceiver when the first link is established; and enabling the second transceiver in a predetermined period after the first link is established to receive a second signal via the second medium for determining if the predetermined order needs to be adjusted.

Preferably, the method further comprises steps of losing the first link when the first transceiver no longer receives a signal after the first link is established; and enabling the second transceiver according to the predetermined order when losing the first link.

According to the method described above, the predetermined order is set up by one selected from a group consisting a random, a predetermined and a recurring sorting modes.

According to the method described above, each of the first and the second medium is one selected from a group consisting of an optical fiber, a copper cable, a coaxial cable and a twisted pair cable.

In accordance with another aspect of the present invention, a network device is provided. The network device comprises a physical layer, comprising a first transceiver; a second transceiver; a first communication unit coupled to the first transceiver, and trying to establish a first link via the first transceiver and a first medium; a second communication unit coupled to the second transceiver, and trying to establish a second link via the second transceiver and a second medium; and a media selecting unit coupled to a media access controller, and the first and the second communication units, and enabling one of the first and the second transceivers according to a predetermined order establish a corresponding one of the first and second links, wherein the media access controller transmits a first datum via the first medium by using the first link, and transmits a second datum via the second medium by using the second link.

According to the network device described above, the first communication unit comprises a first signal detector receiving a first signal via the first medium to generate a first connection signal; and the second communication unit comprises a second signal detector receiving a second signal via the second medium to generate a second connection signal.

According to the network device described above, the first link is established in an adjustable period; when the first link is established, at least one of the second signal detector and the second transceiver is disabled; and when the second link is established, at least one of the first signal detector and the first transceiver is disabled.

According to the network device described above, when the first link is established, the second transceiver is enabled in a predetermined period to receive a signal from the second medium for determining if the predetermined order needs to be adjusted.

Preferably, the network device further comprises at least a third transceiver, wherein after the first link is established, when the first transceiver no longer receives a signal via the first medium, the first link is lost; and when the first link is lost, the media selecting unit enables one of the transceivers other than the first transceiver and tries to establish a corresponding link according to the predetermined order.

According to the network device described above, the predetermined order is set up by one selected from a group consisting of a random mode, a predetermined mode and a recurring sorting mode.

According to the network device described above, each of the first and the second media is one selected from a group consisting of an optical fiber, a copper cable, a coaxial cable and a twisted pair cable.

In accordance with a further aspect of the present invention, a physical layer circuit is provided. The physical layer circuit comprises a circuit interface coupled to a media access controller circuit; a first transceiver; a second transceiver; a first communication unit coupled to the first transceiver, and trying to establish a first link via the first transceiver and a first medium; a second communication unit coupled to the second transceiver, and trying to establish a second link via the second transceiver and a second medium; and a media selecting unit coupled to the media access controller circuit, and the first and the second communication units, enabling one of the first and the second transceivers according to a predetermined order to establish a corresponding one of the first and second links, wherein the media access controller circuit transmits a first datum via the first medium by using the first link, and transmits a second datum via the second medium by using the second link.

According to the physical layer circuit described above, the first communication unit further comprises a first signal detector receiving a first signal via the first medium to generate a first connection signal; and the second communication unit further comprises a second signal detector receiving a second signal via the second medium to generate a second connection signal.

According to the physical layer circuit described above, the first link is established in an adjustable period; when the first link is established, at least one of the second signal detector and the second transceiver is disabled; and when the second link is established, at least one of the first signal detector and the first transceiver is disabled.

According to the physical layer circuit described above, when the first link is established, the second transceiver is enabled in a predetermined period to receive a signal via the second medium for determining if the predetermined order needs to be adjusted.

Preferably, the physical layer circuit further comprises at least a third transceiver, wherein after the first link is established, when the first transceiver no longer receives a signal from the first medium, the first link is lost; and when the first link is lost, the media selecting unit enables one of the transceivers other than the first transceiver and tries to establish a corresponding link according to the predetermined order.

According to the physical layer circuit described above, the predetermined order is set up by one selected from a group consisting of a random mode, a predetermined mode and a recurring sorting mode.

According to the physical layer circuit described above, each of the first and the second media is one selected from a group consisting of an optical fiber, a copper cable, a coaxial cable and a twisted pair cable.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing a structure of a network media selecting device according to a preferred embodiment of the present invention; and

FIG. 2 is a flow chart of a network media selecting method according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

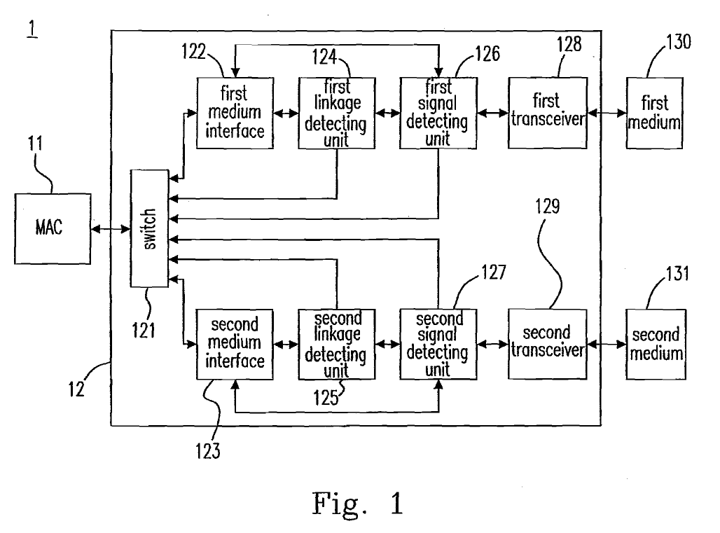

FIG. 1 is a diagram showing a structure of a network media selecting device according to a preferred embodiment of the present invention. The network media selecting device 1 comprises a media access control (MAC) 11 and a physical layer 12. The physical layer 12 includes a switch 121, a first medium interface 122, a second medium interface 123, a first linkage detecting unit 124, a second linkage detecting unit 125, a first signal detecting unit 126, a second signal detecting unit 127, a first transceiver 128 and a second transceiver 129, wherein the first transceiver 128 is connected to a first medium 130, and the second transceiver 129 is connected to a second medium 131.

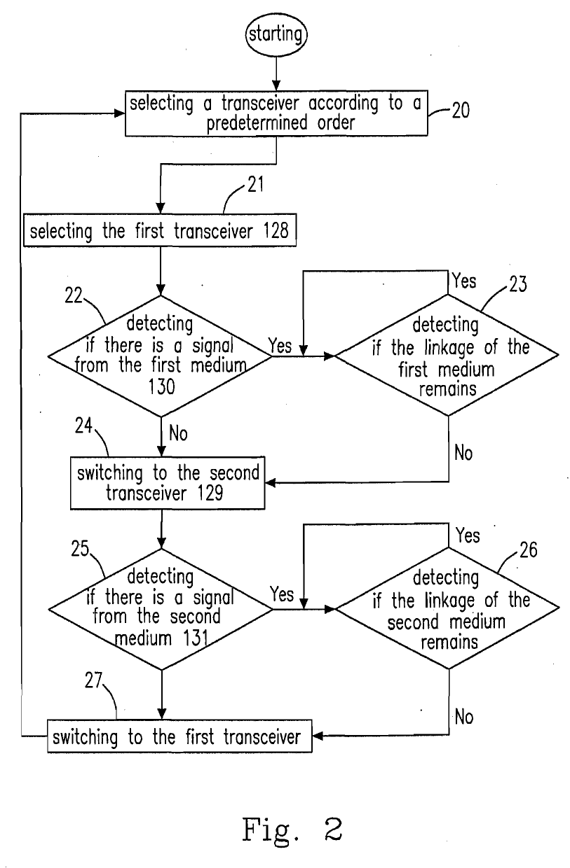

FIG. 2 is a flow chart of a network media selecting method according to a preferred embodiment of the present invention. In the beginning, the switch 121 selects a transceiver to monitor a medium. In an embodiment, the selection is made according to one of a random mode, a predetermined mode and a recurring sorting mode.

In an embodiment, the switch 121 selects a transceiver according to a predetermined order (step 20). For example, when the first transceiver 128 is selected to monitor the first medium 130 (step 21), the first signal detecting unit 126 is used to detect if there is a first connection signal from the first medium 130 (step 22). If there is no signal from the first medium 130, the switch 121 switches to the second transceiver 129, and the second signal detecting unit 127 is used to determine if there is a second connection signal from the second medium 131 (step 25). If there is still no signal from the second medium 131, it means there is no medium linked to the network media selecting device 1 currently. The switch 121 selects one of the transceivers every specific period according to the predetermined order to detect the connection signals, wherein the predetermined order is selected from one of the random, the predetermined and the recurring sorting modes, and the specific period is set according to the requirements.

In another embodiment, if the first connection signal of the first medium 130, corresponding to the first transceiver 128, is detected by the first signal detecting unit 126, it means that the linkage between the network media selecting device 1 and the first medium 130 is established and the data are ready to be transferred. Next, the first linkage detecting unit 124 continuously detects if the linkage between the network media selecting device 1 and the first medium 130 remains for proceeding the data transfer (step 23). If the linkage does not remain, i.e. the linkage is interrupted because the wire is broken or pulled out, etc., the switch 121 switches to the second transceiver 129 to detect the signal (step 24). If the linkage remains, the first linkage detecting unit 124 will continuously detect if the linkage remains for proceeding the data transfer (step 23) until the linkage is inexistent. While the interruption of the linkage is confirmed, the first transceiver 128 will be turned off and the switch 121 selects one transceiver from the transceivers which are currently connected to the network media selecting device 1. At this time, if the second medium 131 is connected to the second transceiver 129, the switch 121 turns on the second transceiver 129 and the above detecting steps will be repeated for the second medium 131 corresponding to the second transceiver 129 (steps 25-27). Of course, when the linkage between the first medium 130 and the network media selecting device 1 remains, the first transceiver 128 is turned on and the second transceiver 129 is turned off.

In another embodiment, when the data is transferred between the first medium 130 and the network media selecting device 1 via the first transceiver 128, if the linkage therebetween is interrupted, the switch 121 requests the first signal detecting unit 126 to detect the first connection signal from the first medium 130 again through the first medium interface 122. When the interruption of the linkage is confirmed, the first transceiver 128 is turned off, and then the switch 121 selects one medium from the media which are currently connected to the network media selecting device 1. At this time, if the second medium 131 is connected to the second transceiver 129, the switch 121 detects the connection signal of the second transceiver 129 and determines whether to proceed the subsequent processes.

In another embodiment, when the linkage between the network media selecting device 1 and the second medium 131 remains for proceeding the data transfer via the second transceiver 129 and the first medium 130 is suddenly connected to the first transceiver 128 and tries to transfer data, the connection of the first medium 130 will be ignored by the switch 121 and the data transfer between the network media selecting device 1 and the second medium 131 via the second transceiver 129 is kept on. When the linkage between the second medium 131 and the second transceiver 129 is interrupted, the switch 121 reselects one medium from the media which are currently connected to the network media selecting device 1. In other words, once a medium is selected to transfer data by the switch 121, unless the linkage between the network media selecting device 1 and the medium is interrupted, i.e. the linkage therebetween is removed, the wire is broken, etc., only the transceiver corresponding to the medium is turned on by the network media selecting device 1 and the other transceivers are turned off to reduce power consumption.

In yet another embodiment, a plurality of transceivers are configured in the network media selecting device in the present invention to be further connected to a plurality of media, and only one medium's connection signal and connection state will be detected at a time. When the medium has no data transmission, the monitor to the medium will be turned off.

The media connected to the network media selecting device are optical fibers, copper cables, coaxial cables or twisted pair cables. When the connected medium is the optical fiber, the period for detecting if there is a connection signal from the medium is 200 microseconds and the period for detecting if the linkage remains is 200 microseconds. When the connected medium is the copper cable, the period for detecting if there is a connection signal from the medium is 1 second and the period for detecting if the linkage remains is 5, 10, 20 or 30 seconds.

Based on the above, the present invention can be applicable to a plurality of different media and rapidly detect if there are linkages established with these media, with the addition of the signal detecting unit. Only if the linkage is detected, the following auto-negotiation, data transmission and monitor of the connection state will be proceeded. Besides, the method to check only one medium at a time can reduce power consumption than the conventional technique and possess the characteristics of rapid process and environmental protection.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for operating a network device, comprising steps of:
providing a first transceiver to establish a first link via a first medium;
providing a second transceiver to establish a second link via a second medium; and
enabling one of the first and the second transceivers to establish a corresponding one of the first and second links according to a predetermined order,
wherein a media access controller transmits a first datum via the first medium by using the first link, and transmits a second datum via the second medium by using the second link.

2. A method as claimed in claim 1, further comprising steps of:
establishing the first link in an adjustable period;
generating a first connection signal while the first transceiver receives a first signal via the first medium after the first transceiver is enabled;
disabling the second transceiver when the first link is established; and
enabling the second transceiver in a predetermined period after the first link is established to receive a second signal via the second medium for determining if the predetermined order needs to be adjusted.

3. A method as claimed in claim 1, further comprising steps of:
losing the first link when the first transceiver no longer receives a signal after the first link is established; and
enabling the second transceiver according to the predetermined order when losing the first link.

4. A method as claimed in claim 1, wherein the predetermined order is set up by one selected from a group consisting a random, a predetermined and a recurring sorting modes.

5. A method as claimed in claim 1, wherein each of the first and the second medium is one selected from a group consisting of an optical fiber, a copper cable, a coaxial cable and a twisted pair cable.

6. A network device, comprising:
a physical layer, comprising:
a first transceiver;
a second transceiver;
a first communication unit coupled to the first transceiver, and trying to establish a first link via the first transceiver and a first medium;
a second communication unit coupled to the second transceiver, and trying to establish a second link via the second transceiver and a second medium; and
a media selecting unit coupled to a media access controller, and the first and the second communication units, and enabling one of the first and the second transceivers according to a predetermined order to establish a corresponding one of the first and second links,
wherein the media access controller transmits a first datum via the first medium by using the first link, and transmits a second datum via the second medium by using the second link.

7. A network device as claimed in claim 6, wherein
the first communication unit comprises a first signal detector receiving a first signal via the first medium to generate a first connection signal; and
the second communication unit comprises a second signal detector receiving a second signal via the second medium to generate a second connection signal.

8. A network device as claimed in claim 7, wherein
the first link is established in an adjustable period;
when the first link is established, at least one of the second signal detector and the second transceiver is disabled; and
when the second link is established, at least one of the first signal detector and the first transceiver is disabled.

9. A network device as claimed in claim 6, wherein when the first link is established, the second transceiver is enabled in a predetermined period to receive a signal via the second medium for determining if the predetermined order needs to be adjusted.

10. A network device as claimed in claim 6, further comprising at least a third transceiver, wherein after the first link is established, when the first transceiver no longer receives a signal via the first medium, the first link is lost; and when the first link is lost, the media selecting unit enables one of the transceivers other than the first transceiver and tries to establish a corresponding link according to the predetermined order.

11. A network device as claimed in claim 6, wherein the predetermined order is set up by one selected from a group consisting of a random mode, a predetermined mode and a recurring sorting mode.

12. A network device as claimed in claim 6, wherein each of the first and the second medium is one selected from a group consisting of an optical fiber, a copper cable, a coaxial cable and a twisted pair cable.

13. A physical layer circuit, comprising:
a circuit interface coupled to a media access controller circuit;
a first transceiver;
a second transceiver;
a first communication unit coupled to the first transceiver, and trying to establish a first link via the first transceiver and a first medium;
a second communication unit coupled to the second transceiver, and trying to establish a second link via the second transceiver and a second medium; and
a media selecting unit coupled to the media access controller circuit, and the first and the second communication units, enabling one of the first and the second transceivers according to a predetermined order for to establish a corresponding one of the first and second links,
wherein the media access controller circuit transmits a first datum via the first medium by using the first link, and transmits a second datum via the second medium by using the second link.

14. A physical layer circuit as claimed in claim 13, wherein
the first communication unit further comprises a first signal detector receiving a first signal via the first medium to generate a first connection signal; and
the second communication unit further comprises a second signal detector receiving a second signal via the second medium to generate a second connection signal.

15. A physical layer circuit as claimed in claim 13, wherein
the first link is established in an adjustable period;
when the first link is established, at least one of the second signal detector and the second transceiver is disabled; and
when the second link is established, at least one of the first signal detector and the first transceiver is disabled.

16. A physical layer circuit as claimed in claim 13, wherein when the first link is established, the second transceiver is enabled in a predetermined period to receive a signal via the second medium for determining if the predetermined order needs to be adjusted.

17. A physical layer circuit as claimed in claim 13, further comprising at least a third transceiver, wherein after the first link is established, when the first transceiver no longer receives a signal from the first medium, the first link is lost; and when the first link is lost, the media selecting unit enables one of the transceivers other than the first transceiver and tries to establish a corresponding link according to the predetermined order.

18. A physical layer circuit as claimed in claim 13, wherein the predetermined order is set up by one selected from a group consisting of a random mode, a predetermined mode and a recurring sorting mode.

19. A physical layer circuit as claimed in claim 13, wherein each of the first and the second medium is one selected from a group consisting of an optical fiber, a copper cable, a coaxial cable and a twisted pair cable.
